(19) United States
(12) Patent Application Publication
(10) Pub. No.: US 2015/0129530 A1
(43) Pub. Date: May 14, 2015

(54) Absorbent neck ring for a baby bottle

(71) Applicant: DeeAnna Marek, Brenham, TX (US)

(72) Inventor: DeeAnna Marek, Brenham, TX (US)

(21) Appl. No.: 14/535,727

(22) Filed: Nov. 7, 2014

Related U.S. Application Data
(60) Provisional application No. 61/901,636, filed on Nov. 8, 2013.

(51) Int. Cl. A61J 9/00; A61J 11/00

(52) U.S. Cl. CPC A61J 9/00; A61J 11/0075
USPC 215/11.1; 215/230

(57) ABSTRACT

An absorbent neck ring for a baby bottle is fitted to the bottle, preferably with elasticized cotton or other elastic fabric. The ring ensures that any leaks from the bottle or the baby's mouth will be absorbed, rather than dripping on clothing or elsewhere. The ring may be laundered and re-used, or it may be used in a single use capacity. The ring covers the bottle cap and provides a circular aperture at its center for the nipple to pass through. The ring may be provided in various colors and decorative configurations, such as an image of a teddy bear's face or a baseball.

### CROSS-REFERENCE TO RELATED APPLICATIONS

This application claims priority to U.S. Provisional Application No. 61/901,636, filed Nov. 8, 2013, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to infant care accessories and in particular to an absorbent neck ring for a baby bottle. The parents of infants, and those toddlers who are still bottle feeding, frequently face the problem of one or two drops of milk or formula trickling down their child's neck from the bottle. This may be due to a failure to completely seal the cap or the child's inability to retain and swallow all of the extracted milk or formula. These few drops of milk or formula are annoying, causing soiling and stains to the clothing of parent and child, as well as the upholstery of furniture and vehicles. Various protective measures, such as wrapping a washcloth around the bottle, have been attempted but these are less than elegant, and a better solution is sought by most parents.

### SUMMARY OF THE INVENTION

Accordingly, the invention is directed to an absorbent neck ring for a baby bottle. The ring is fitted to the bottle, preferably with elasticized cotton or other elastic fabric. The ring ensures that any leaks from the bottle or the baby's mouth will be absorbed, rather than dripping on clothing or elsewhere. The ring may be laundered and re-used, or it may be used in a single use capacity. The ring covers the bottle cap and provides a circular aperture at its center for the nipple to pass through. The ring may be provided in various colors and decorative configurations, such as an image of a teddy bear's face or a baseball.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate four embodiments of the invention and, together with the description, serve to explain the principles of the invention.

FIG. 1 is a top view of the first exemplary embodiment, displaying the ring 10A, and the aperture 11.

FIG. 2 is a top view of the second exemplary embodiment, displaying the ring 10B, and the aperture 11.

FIG. 3 is a top view of the third exemplary embodiment, displaying the ring 10C, and the aperture 11.

FIG. 4 is a top view of the fourth exemplary embodiment, displaying the ring 10D, and the aperture 11.

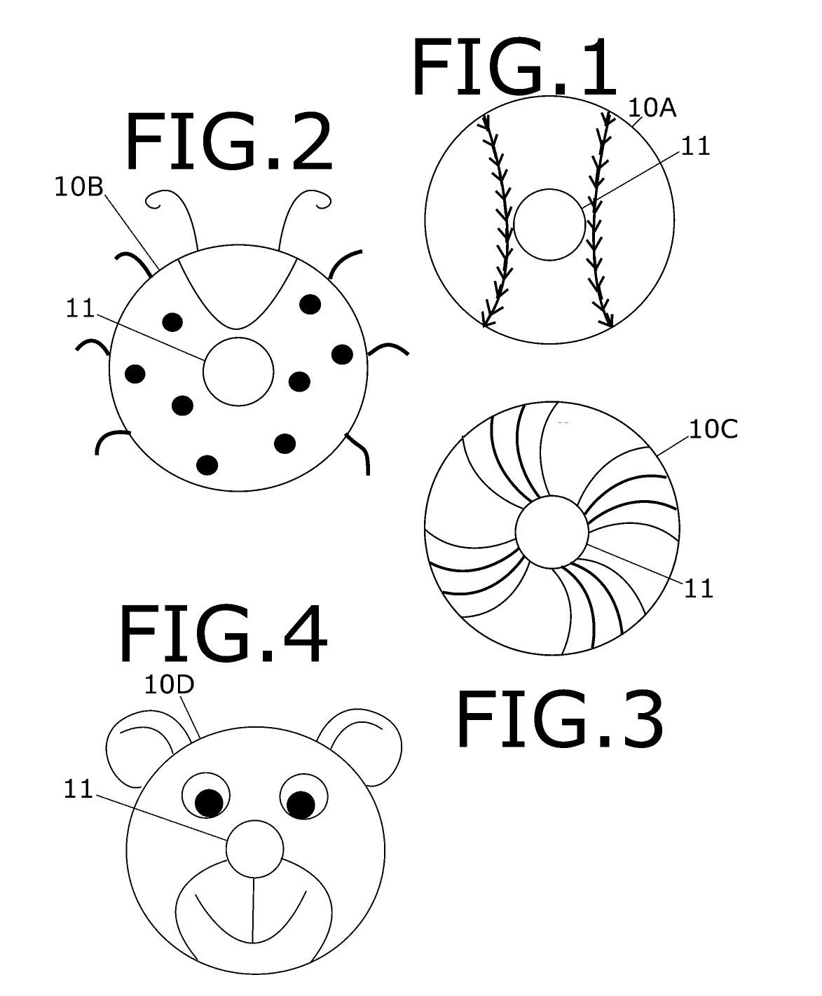

### DETAILED DESCRIPTION OF THE INVENTION

Referring now to the invention in more detail, the invention is directed to an absorbent neck ring 10A-10D for a baby bottle. The ring 10A-10D is fitted to the bottle, preferably with elasticized cotton or other elastic fabric. The ring 10A-10D ensures that any leaks from the bottle or the baby's mouth will be absorbed, rather than dripping on clothing or elsewhere. The ring 10A-10D may be laundered and re-used, or it may be used in a single use capacity. The ring 10A-10D covers the bottle cap and provides a circular aperture 11 at its center for the nipple to pass through. The ring 10A-10D may be provided in various colors and decorative configurations, such as an image of a teddy bear's face or a baseball. The ring 10A-10D is preferably circular in shape such that the ring fully surrounds its center and is substantially evenly distributed about the aperture 11 on all sides, and not just the side of the bottle facing the feeding child. The ring 10A-10D is preferably semi-rigid such that the ring can hold its shape and remain about perpendicular to the bottle or substantially coplanar to the aperture 11 regardless of orientation; this may be achieved by constructing the ring of multiple layers of heavy fabric or by inserting a semi-rigid core of cardboard or plastic within the ring.

The device is presented in four exemplary embodiments. The first exemplary embodiment features the decorative image of a baseball on the ring 10A. The second exemplary embodiment features the decorative image of a ladybug on the ring 10B. The third exemplary embodiment features an abstract decorative image on the ring 10C. The fourth exemplary embodiment features the decorative image of a teddy bear's face on the ring 10D.

To use any of the exemplary embodiments, the user places the ring 10A-10D on the bottle cap, stretching the elastic down until the cap is covered completely, and the nipple protrudes through the aperture 11. The bottle 10A-10D is then provided to the child for feeding. Any stray drops of liquid milk or formula (generically a feeding liquid, which may also include a fruit juice, liquid medicine, or other liquid for oral administration via a bottle) resulting from feeding will be caught and absorbed by the ring 10A-10D and will not soil the clothing or skin of the child or the caregiver.

The ring 10A-10D is preferably manufactured from a flexible, durable, highly absorbent fabric with elastic properties, such as terry cloth or elasticized cotton, but having the ability to remain semi-rigid and upright when installed on the bottle. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. An absorbent neck ring for a baby bottle comprising a ring; said ring having a circular aperture at its center; said ring being made of an absorbent and elastic material.

2. A method of use of the absorbent neck ring for a baby bottle of claim 1 comprising stretching said ring over a baby bottle such that the nipple of said baby bottle protrudes through said circular aperture, and feeding a child using said baby bottle such that stray drops of feeding liquid will be absorbed by said ring.

3. The absorbent neck ring for a baby bottle of claim 1 wherein said ring is circular in shape such that said ring fully surrounds its center and is substantially evenly distributed about said aperture on all sides.

4. The absorbent neck ring for a baby bottle of claim 1 wherein said ring is semi-rigid such that said ring can hold its shape and remain substantially coplanar to said aperture regardless of orientation.

5. A method of use of the absorbent neck ring for a baby bottle of claim 3 comprising stretching said ring over a baby bottle such that the nipple of said baby bottle protrudes through said circular aperture, and feeding a child using said baby bottle such that stray drops of feeding liquid will be absorbed by said ring.

6. A method of use of the absorbent neck ring for a baby bottle of claim 4 comprising stretching said ring over a baby bottle such that the nipple of said baby bottle protrudes through said circular aperture, and feeding a child using said baby bottle such that stray drops of feeding liquid will be absorbed by said ring.

7. The absorbent neck ring for a baby bottle of claim 3 wherein said ring is semi-rigid such that said ring can hold its shape and remain substantially coplanar to said aperture regardless of orientation.

8. A method of use of the absorbent neck ring for a baby bottle of claim 7 comprising stretching said ring over a baby bottle such that the nipple of said baby bottle protrudes through said circular aperture, and feeding a child using said baby bottle such that stray drops of feeding liquid will be absorbed by said ring.
